(19) United States
(12) Patent Application Publication
(10) Pub. No.: US 2015/0198531 A1
(43) Pub. Date: Jul. 16, 2015

(54) Long Range Product Authenticator

(71) Applicants: Vitaly Talyansky, Portland, OR (US); Edward Talyansky, Battle Ground, WA (US)

(72) Inventors: Vitaly Talyansky, Portland, OR (US); Edward Talyansky, Battle Ground, WA (US)

(21) Appl. No.: 14/155,765

(22) Filed: Jan. 15, 2014

(51) Int. Cl. G01N 21/64

(52) U.S. Cl. CPC G01N 21/645; G01N 2021/6463; G01N 2201/06113

(57) ABSTRACT

Methods and apparatus for a long range product authenticator. An example apparatus includes a sample that produces a luminescent emission in response to illumination by electromagnetic radiation with a first wavelength, a laser to illuminate the sample with electromagnetic radiation that has the first wavelength, wherein the laser illuminates the sample during a first duration of time and does not illuminate the sample during a second duration of time, a photo element to detect the luminescent emission of the sample during the second duration of time and a lens to focus the luminescent emission of the sample onto the photo element.

### FIELD OF THE DISCLOSURE

The present disclosure relates generally to product authentication and, more particularly, to a long range product authenticator.

### BACKGROUND

Authentic products can be copied and these counterfeit products may be sold or used by consumers. Counterfeit products can be harmful to the producers and resellers of authentic products and to the consumers of counterfeit products.

### BRIEF DESCRIPTION OF THE DRAWINGS

FIG. 1 is a block diagram of an example long range product authenticator constructed in accordance with the teachings of this disclosure.

FIG. 2 is a figure showing the luminescent response of the sample of FIG. 1.

FIG. 3 is a figure showing the decay time of the luminescent response of the sample of FIG. 1.

FIG. 4 is a flowchart representative of example machine readable instructions that may be executed to implement the example long range product authenticator of FIG. 1.

FIG. 5 is a figure showing the emission of the laser of FIG. 1.

FIG. 6 is a figure showing the emission of the laser of FIG. 1 and the luminescent response of the sample of FIG. 1.

FIG. 7 is a block diagram of an example processing system capable of executing the example machine readable instructions of FIG. 2 to implement the example tester of FIG. 1.

### DETAILED DESCRIPTION

Counterfeit products can cause significant economic and other damage to both the purveyor of authentic non-counterfeit products and the consumer of the counterfeit products. In order to combat counterfeiting, many products contain materials embedded in the product or in the packaging and/or labeling for the product that allow the product to be authenticated. Counterfeit products will not have this material and therefore cannot be authenticated.

One method of authenticating products is for a product to contain luminescent material embedded in the product and/or the packaging or labeling of the product. Luminescence is a response of certain optical materials to electromagnetic radiation. More specifically, a luminescent material that is struck with electromagnetic radiation at a certain frequency will emit electromagnetic radiation in response at a different frequency. By embedding a controlled luminescent material in a product, the product can later be tested for authenticity by hitting the product with electromagnetic radiation at an appropriate frequency and testing for the corresponding luminescent response. A counterfeit product that does not have the luminescent material will not produce the luminescent response. Furthermore, the embedded luminescent material can be invisible to the naked eye. Using such a luminescent material as a security feature in a product will make the product difficult to counterfeit.

Typically, a product with a luminescent authentication feature will be authenticated by illuminating the product with a light source and measuring the luminescent response from the product. Often the luminescent response of the product will be light emitted by the product with a wavelength that is relatively close to the wavelength of the illuminating source. To authenticate the product, a product authenticator will need to measure the luminescence of the product without measuring the emission of the illuminating source. Thus, the product authenticator must be able to distinguish between the strong signal from the illuminating source and the much weaker luminescent response of the product (e.g., by using optical filters). However, this can be difficult if the wavelength of the illuminating source is within nanometers of the wavelength of the luminescent response. Furthermore, using traditional light sources such as ultraviolet lamps and infrared and/or visible LEDs as the illumination source only allows products to be authenticated when they are in close proximity to the illumination source since the range of these illumination sources is relatively small.

Example methods, apparatus, and/or articles of manufacture disclosed herein provide a product authenticator that uses a laser as the illuminating source. The emission of a laser has a relatively large range. Therefore, using a laser illumination source allows products to be authenticated at a distance. In examples disclosed herein, a product authenticator uses inorganic luminescent material embedded in a product. The luminescent response of the inorganic material has a relatively long decay time (e.g., 10-100 ms). In examples disclosed herein, this long decay time allows the luminescent response of the product to be distinguished from the illumination source even if they have the same wavelength by only looking at the luminescent response of the product after the illuminating device has been turned off

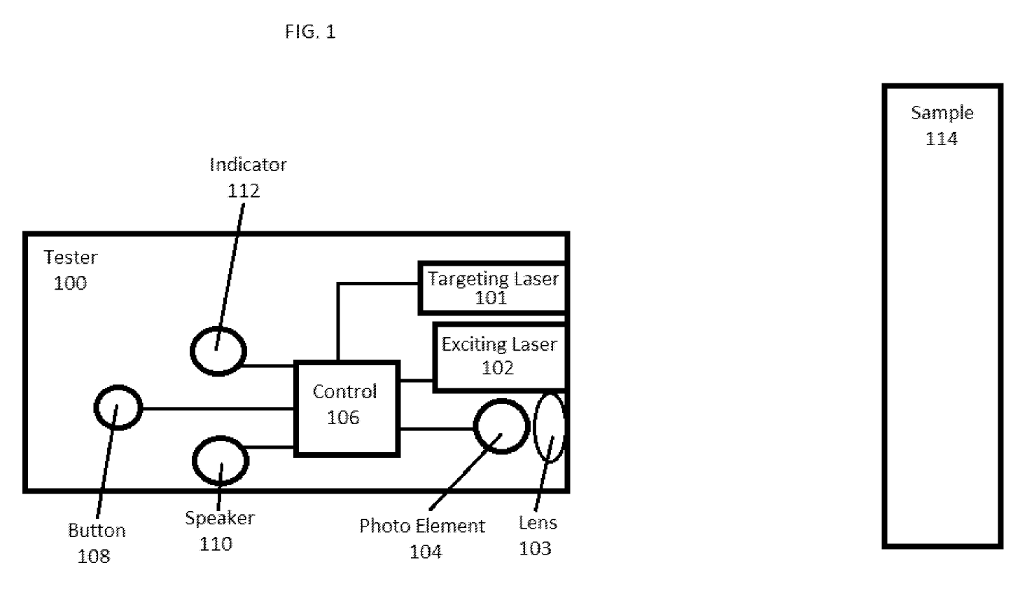

FIG. 1 is a block diagram of an example long range product authenticator constructed in accordance with the teachings of this disclosure. The example of FIG. 1 includes a tester 100 and a sample 114. The example tester 100 of FIG. 1 includes a targeting laser 101, an exciting laser 102, a lens 103, a photo element 104, a control 106, a button 108, a speaker 110 and an indicator 112.

In the illustrated example, the targeting laser 101 is a visible laser that is used to aim the tester 100 at the sample 114. The example targeting laser 101 may be a gaseous laser, a solid state laser, a laser diode or any other type of laser. The example targeting laser 101 emits visible light so that a user of the example tester 100 can see what the tester 100 is pointing at and aim the tester 100 at the sample 114. In the illustrated example, the targeting laser 101 is parallel to the exciting laser 102 such that the targeting laser 101 illuminates nearly the same spot that the exciting laser 102 is pointed at. In some examples, the targeting laser 101 is omitted from the tester 100. In other examples, the tester 100 includes multiple targeting lasers arranged in an array or other pattern to more clearly illuminate the target being aimed at (i.e., the sample 114).

In the illustrated example, the exciting laser 102 emits a laser beam of a particular wavelength directed towards the sample 114 to excite the sample 114. The example exciting laser 102 may be a gaseous laser, a solid state laser, a laser diode or any other type of laser device. In the illustrated example, the exciting laser 102 emits infrared light. Because infrared light is invisible to the naked eye, in the illustrated example, the targeting laser 101 is used to aim the tester 100 and accordingly the exciting laser 102 at the sample 114. In other examples, the laser beam emitted by the example exciting laser 102 may be in the visible region, ultraviolet region or any other region of the electromagnetic spectrum. In some examples where the exciting laser 102 emits visible light, the exciting laser 102 is used to aim the tester 100 rather than the targeting laser 101. The laser beam emitted by the example exciting laser 102 has a wavelength that creates a luminescent response in the example sample 114 and causes the sample 114 to emit light that is passed through the example lens 103 and is detected by the example photo element 104.

In the illustrated example, the lens 103 focuses the luminescent light emitted by the sample 114 onto the photo element 104. The example lens 103 may be of any type, shape or design such that light emitted by the sample 114 is focused on and detected by the example photo element 104. The example lens 103 allows light emitted by the sample 114 to be detected by the example photo element 104 even when the sample 114 is at a significant distance from the tester 100.

In the illustrated example, the photo element 104 detects light emitted by the sample 114 that passes through the lens 103. In the illustrated example, the photo element 104 is a photodiode that responds to the luminescent light emitted by the sample 114. In other examples, the photo element 104 may be any other device capable of detecting light or other electromagnetic radiation emitted by the sample 114 that passes through the lens 103.

In the illustrated example, the control 106 is an element that controls the operation of the tester 100. The example control 106 receives signals from the example photo element 104 and the example button 108 and the control 106 sends signals to the example indictor 112, the example speaker 110 and the example exciting laser 102.

In the illustrated example, the button 108 is used to initiate an authentication of the sample 114. When the example button 108 is pressed, the button 108 sends a signal to the example control 106 indicating that the sample 114 is to be authenticated. In other examples, the button 108 may be replaced with any element capable of indicating to the control 106 that it should begin authenticating the sample 114.

In the illustrated example, the speaker 110 is used to give an audible indication to a user of the tester 100 of the results of an authentication of the sample 114. In the illustrated example, the speaker 110 plays a certain sound when the sample 114 has been authenticated and a different sound when the sample 114 has not been authenticated. In some examples, the speaker 110 may play other sounds to indicate other things such as the condition of the tester 100 or particular details about the sample 114 being authenticated. In other examples, the speaker 110 is no be included in the tester 100.

In the illustrated example, the indicator 112 is used to give a visual indication to a user of the tester 100 of the results of an authentication of the sample 114. In the illustrated example, the indicator 112 is an LED that turns on when the sample 114 is successfully authenticated. In other examples, any other element capable of making a visual indication may be used as the indicator 112. In some examples, the indictor 112 may consist of multiple LEDs and/or other devices that each indicate a different state of the tester 100 such as one LED to indicate a positive authentication and another LED to indicate a negative authentication.

In the illustrated example, the sample 114 is the item or product that is to be authenticated. The example sample 114 is authenticated by the example tester 100. In the illustrated example, the sample 114 contains taggant, which is a material that has a luminescent response such that when light or other electromagnetic radiation of a certain wavelength hits the sample 114, the taggant in the sample 114 emits light or other electromagnetic radiation at a different wavelength. In the illustrated example, the taggant is an inorganic material that creates a luminescent response when it is hit with an illuminating source of the appropriate wavelength and it continues to produce a luminescent response for several milliseconds after the illuminating source is removed.

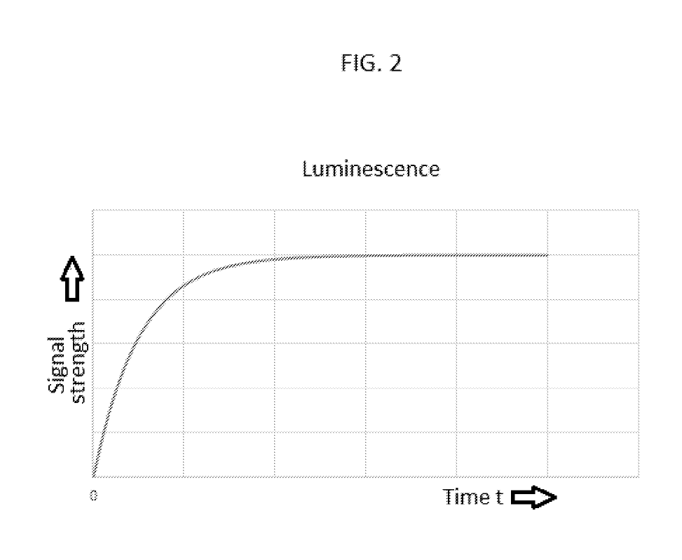

FIG. 2 illustrates the strength of the luminescent response of the taggant in the example sample 114 over time after an illuminating source (e.g., the exciting laser 102) is turned on at time t=0. In the example of FIG. 2, the luminescent response reaches a plateau shortly after the illuminating source is turned on.

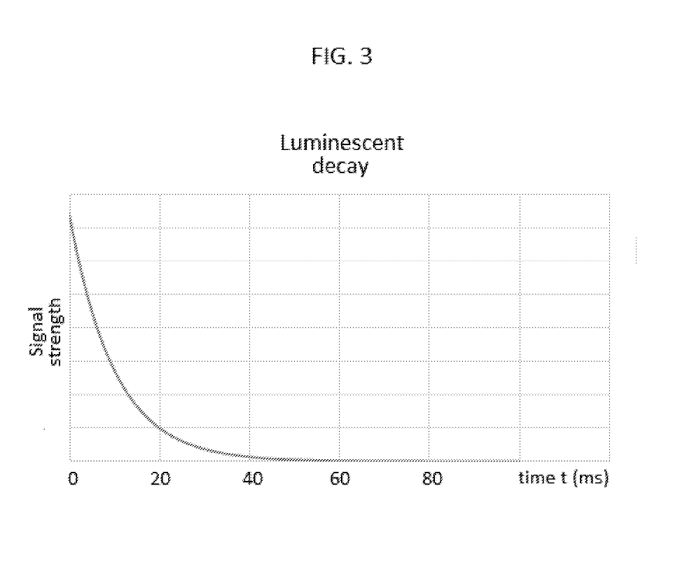

FIG. 3 illustrates the strength of the luminescent response of the taggant in the example sample 114 over time after an illuminating source is turned off at time t=0. In the example of FIG. 3, the luminescent response begins to decay as soon as the illuminating source is removed. However, the luminescent response continues at weaker levels for about 50 milliseconds. In other examples, the luminescent response may decay at different rates such that a luminescent signal is present for anywhere from about 10-100 milliseconds after the illuminating source is removed.

In the illustrated example, the luminescent response produced by the taggant in the sample 114 is invisible to the naked eye and only detectable by the tester 100. In the illustrated example, if no taggant is present in the sample 114, then the sample 114 is not authentic and it does not produce a luminescent response. In the illustrated example, the taggant material is blended into ink that is used to print the labeling for the sample 114. In other examples, the taggant material is introduced into the packaging of the sample 114 and/or the sample 114 itself In some examples, taggant material can be introduced into the sample 114 through impregnating paper or plastic substrate, coating the sample 114 and/or other methods. In some examples, optical taggant material is not used at all and the sample 114 responds to the tester 100 by responding to a changing electric field, a changing magnetic field and/or other methods.

While an example manner of implementing the long range product authenticator has been illustrated in FIG. 1, one or more of the elements, processes and/or devices illustrated in FIG. 1 may be combined, divided, re-arranged, omitted, eliminated and/or implemented in any other way. Further, the example targeting laser 101, the example exciting laser 102, the example lens 103, the example photo element 104, the example control 106, the example button 108, the example speaker 110, the example indicator 112, the example sample 114 and/or, more generally, the example long range product authenticator of FIG. 1 may be implemented by hardware, software, firmware and/or any combination of hardware, software and/or firmware. Thus, for example, any of the example targeting laser 101, the example exciting laser 102, the example lens 103, the example photo element 104, the example control 106, the example button 108, the example speaker 110, the example indicator 112, the example sample 114 and/or, more generally, the example long range product authenticator of FIG. 1 could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example targeting laser 101, the example exciting laser 102, the example lens 103, the example photo element 104, the example control 106, the example button 108, the example speaker 110, the example indicator 112, the example sample 114 and/or, more generally, the example long range product authenticator of FIG. 1 is hereby expressly defined to include a tangible computer readable storage medium such as a memory, DVD, CD, Blu-ray, etc. storing the software and/or firmware. Further still, the example targeting laser 101, the example exciting laser 102, the example lens 103, the example photo element 104, the example control 106, the example button 108, the example speaker 110, the example indicator 112, the example sample 114 and/or, more generally, the example long range product authenticator of FIG. 1 may include more than one of any or all of the illustrated elements, processes and devices.

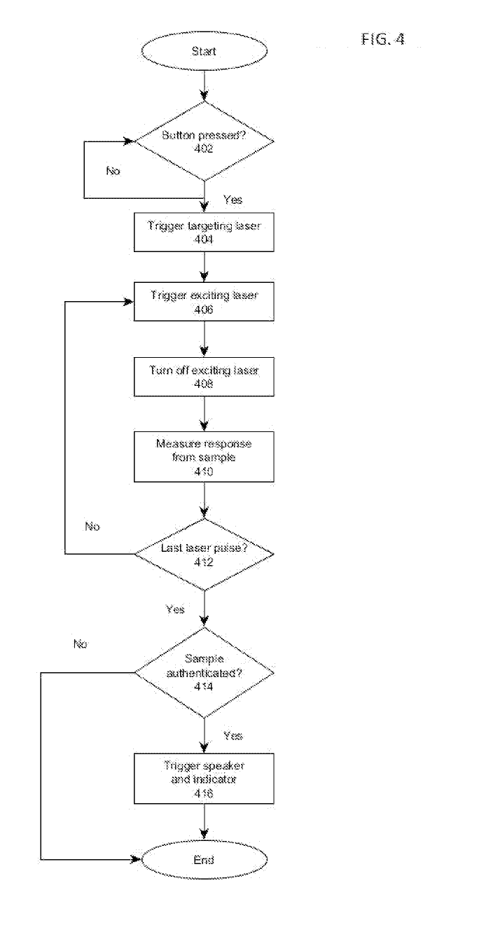

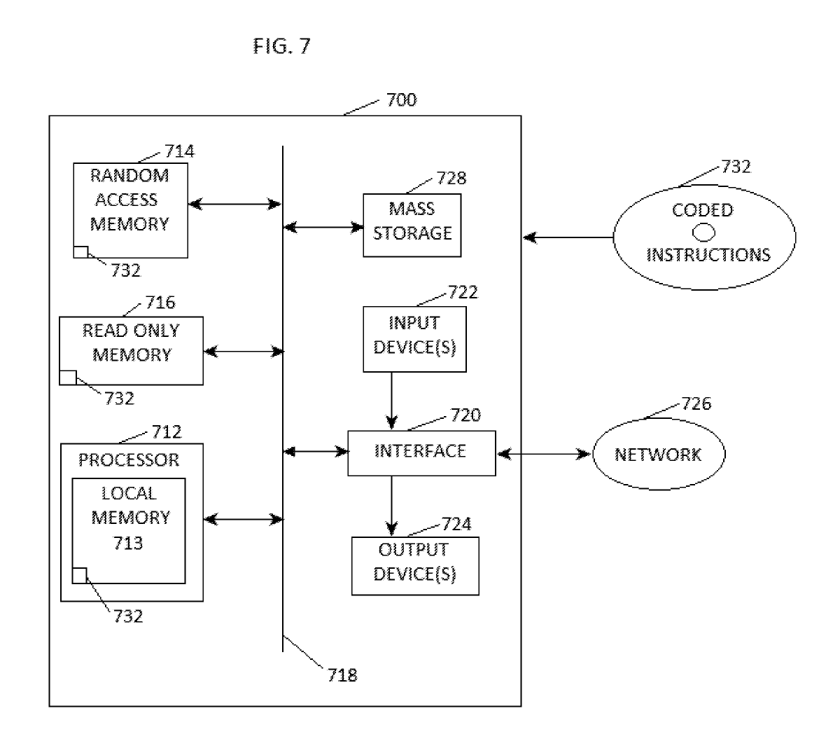

FIG. 4 is a flowchart representative of example machine readable instructions for implementing the example long range product authenticator of FIG. 1. In the example flowchart of FIG. 4, the machine readable instructions comprise program(s) for execution by a processor such as the processor 712 shown in the example computer 700 discussed below in connection with FIG. 7. The program(s) may be embodied in software stored on a tangible computer readable storage medium such as a CD-ROM, a floppy disk, a flash drive, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program(s) is described with reference to the flowcharts illustrated in FIG. 4, many other methods of implementing the example long range product authenticator of FIG. 1 may alternatively be used. For example, the order of execution of the blocks may be changed, and/or some of the blocks described may be changed, eliminated, or combined.

As mentioned above, the example processes of FIG. 4 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or disk and to exclude propagating signals. Additionally or alternatively, the example processes of FIG. 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage device and/or disk and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 4 begins when the example control 106 determines whether the example button 108 has been pressed (block 402). If the example control 106 determines that the example button 108 has not been pressed (block 402), then control stays at block 402 until the button 108 has been pressed. If the example control 106 determines that the example button 108 has been pressed (block 402), then control passes to block 404.

After the example control 106 determines that the example button 108 has been pressed (block 402), the control 106 triggers the example targeting laser 101 (block 404). This causes the example targeting laser 101 to emit visible light so that a user of the example tester 100 can aim the tester 100 and the example exciting laser 102 at the example sample 114.

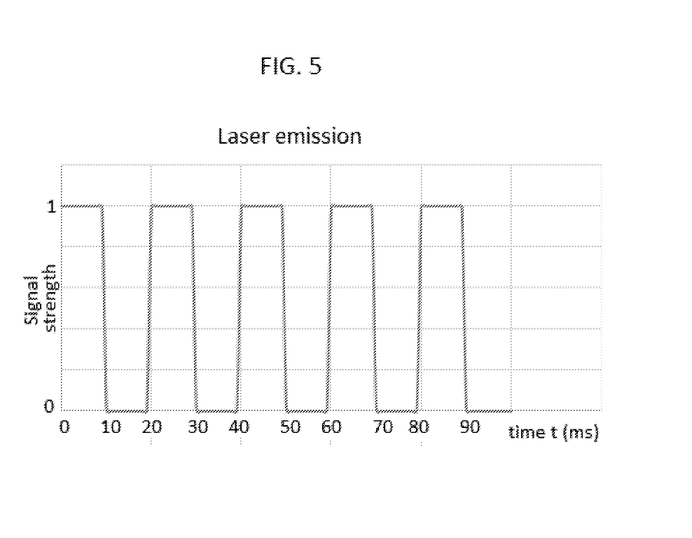

After the example control 106 triggers the example targeting laser 101 (block 404), the control 106 triggers the example exciting laser 102 (block 406). In the illustrated example, the exciting laser 102 emits laser light in a series of short pulses. FIG. 5 illustrates the emission over time of the example exciting laser 102 after the example control 106 initially triggers the exciting laser 102 at time t=0. The example control 106 cycles the example exciting laser 102 on and off several times over a short period of time. In the example of FIG. 5, the exciting laser 102 is turned on to its maximum value for 10 ms and is then turned off for 10 ms repeatedly. In other examples, the exciting laser 102 may be pulsed on and off for different lengths of time.

In the illustrated example, after the control 106 triggers the exciting laser 102 to turn the exciting laser 102 on (block 406), the control 106 turns the exciting laser 102 off after a certain amount of time has elapsed (block 408) as illustrated in FIG. 5. In the example of FIG. 5, the exciting laser 102 is turned off 10 ms after it is turned on. In other examples, a different amount of time may elapse between when the control 106 triggers the exciting laser 102 (block 406) and when the control 106 turns off the laser (block 408).

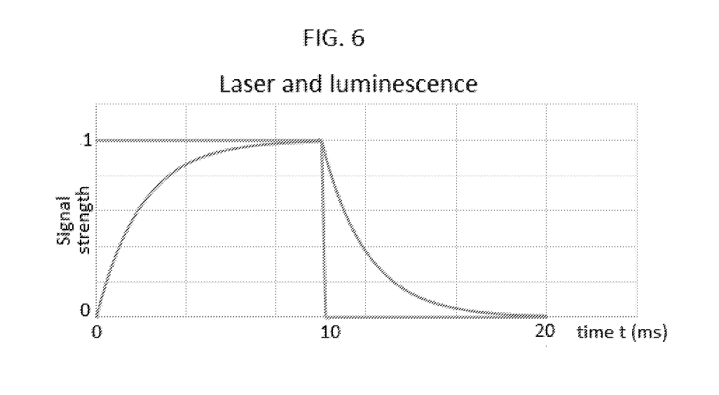

After the example control 106 turns off the example exciting laser 102 (block 408), the control 106 measures the response from the example sample 114 detected by the example photo element 104 (block 410). By measuring the response from the example sample 114 after the example exciting laser 102 is turned off, the example photo element 104 will not detect any signal from the exciting laser 102. However, because the luminescence of the example sample 114 has a relatively long decay time (i.e., 10-100 ms), the luminescence of the sample 114 will still be measurable by the example photo element 104 after the exciting laser 102 is turned off (i.e., the photo element measures the luminescent after-glow). FIG. 6 illustrates this process. In the example of FIG. 6, the exciting laser 102 is turned on at time t=0 and the sample 114 begins to luminescence with increasing signal strength over time until it reaches a plateau around t=10 ms. At time t=10 ms, the exciting laser 102 is turned off and the luminescence of the sample 114 begins to decrease. However, in the example of FIG. 6, the decay time of the sample 114 is about 10 ms. Therefore the luminescence of the sample 114 can be measured between times t=10 ms and t=20 ms without any interference from the exciting laser 102.

After the example control 106 measures the response from the example sample 114 (block 410), the control 106 determines whether the last laser pulse has been triggered (block 412). In the illustrated example, the exciting laser 102 is triggered on and off 10 times and the response of the sample 114 is measured after each laser pulse and the measured response of the sample 114 after each laser pulse is accumulated. This accumulation of measured responses of the sample 114 provides for a more accurate measurement of the average response of the sample 114. In some examples, the exciting laser 102 is only turned on and off once. In other examples, the exciting laser 102 may be pulsed more or less than 10 times or less than 10 times with the corresponding response of the sample 114 measured after each laser pulse. If the example control 106 determines that the example exciting laser 102 has not been pulsed for the last time (block 412), control returns to block 406 to trigger another laser pulse. If the example control 106 determines that the example exciting laser 102 has been pulsed for the last time (block 412), then control passes to block 414.

After the example control 106 determines that the example exciting laser 102 has been pulsed for the last time (block 412), the control 106 determines whether the sample is authentic (block 414). The example control 106 determines whether the example sample 114 is authentic by comparing the accumulated output of the example photo element 104 to a pre-determined threshold. If the example sample 114 is authentic, it will contain taggant, and its accumulated response to the pulses of the example exciting laser 102 detected by the example photo element 104 will be above the threshold. If the example sample 114 is not authentic, it will not contain taggant, and its accumulated response to the pulses of the exciting laser 102 detected by the photo element 104 will be below the threshold. If the example control 106 determines that the example sample 114 is authentic (block 414), the control 106 triggers the example speaker 110 and the example indicator 112 to indicate to the user of the example tester 100 that the sample 114 is authentic (block 416). If the example control 106 determines that the example sample 114 is not authentic (block 414), the example speaker 110 and the example indicator 112 are not triggered. In some examples, if the control 106 determines that the sample 114 is not authentic, the control 106 triggers the speaker 110 and/or the indicator 112 to indicate to the user of the tester 100 that the sample 114 is not authentic. The example of FIG. 4 then ends.

FIG. 7 is a block diagram of a processor platform 700 capable of executing the instructions of FIG. 4 to implement the example long range product authenticator of FIG. 1. The processor platform 700 can be, for example, a server, a personal computer, an Internet appliance, a DVD player, a CD player, a Blu-ray player, a gaming console, a personal video recorder, a smart phone, a tablet, a printer, or any other type of computing device.

The processor platform 700 of the instant example includes a processor 712. As used herein, the term “processor” refers to a logic circuit capable of executing machine readable instructions. For example, the processor 712 can be implemented by one or more microprocessors or controllers from any desired family or manufacturer.

The processor 712 includes a local memory 713 (e.g., a cache) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The processor platform 700 also includes one or more mass storage devices 728 for storing software and data. Examples of such mass storage devices 728 include floppy disk drives, hard drive disks, compact disk drives and digital versatile disk (DVD) drives.

The coded instructions 732 of FIG. 7 may be stored in the mass storage device 728, in the volatile memory 714, in the non-volatile memory 716, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. An apparatus comprising:
a sample that produces a luminescent emission in response to illumination by electromagnetic radiation with a first wavelength;
a laser to illuminate the sample with electromagnetic radiation that has the first wavelength, wherein the laser illuminates the sample during a first duration of time and does not illuminate the sample during a second duration of time;
a photo element to detect the luminescent emission of the sample during the second duration of time; and
a lens to focus the luminescent emission of the sample onto the photo element.

2. The apparatus of claim 1, wherein the laser illuminates the sample with infrared radiation.

3. The apparatus of claim 1, wherein the laser and the sample are separated by a distance of greater than one meter.

4. The apparatus of claim 1, wherein the sample contains taggant that has a luminescent response to the illumination by the laser.

5. The apparatus of claim 4, wherein the taggant consists of inorganic material.

6. The apparatus of claim 1, wherein the luminescent response of the sample has a decay time of greater than 10 milliseconds.

7. The apparatus of claim 1, further comprising a targeting laser to illuminate the sample with visible light.

8. The apparatus of claim 1, wherein the second duration of time immediately follows the first duration of time.

9. A method comprising:
illuminating a sample, during a first duration of time, with a laser that emits electromagnetic radiation of a first wavelength and not illuminating the sample during a second duration of time, wherein the sample produces a luminescent emission in response to illumination by electromagnetic radiation with the first wavelength; and
detecting the luminescent emission of the sample during the second duration of time.

10. The method of claim 9, wherein the laser illuminates the sample with infrared radiation.

11. The method of claim 9, wherein the laser and the sample are separated by a distance greater than one meter.

12. The method of claim 9, wherein the sample contains taggant that has a luminescent response to the illumination by the laser.

13. The method of claim 12, wherein the taggant consists of inorganic material.

14. The method of claim 9, wherein the luminescent response of the sample has a decay time of greater than 10 milliseconds.

15. A tangible machine readable storage medium comprising instructions that, when executed, cause a machine to at least:
illuminate a sample, during a first duration of time, with a laser that emits electromagnetic radiation of a first wavelength and not illuminate the sample during a second duration of time, wherein the sample produces a luminescent emission in response to illumination by electromagnetic radiation with the first wavelength; and
detect the luminescent emission of the sample during the second duration of time.

16. The storage medium of claim 15, wherein laser illuminates the sample with infrared radiation.

17. The storage medium of claim 15, wherein the laser and the sample are separated by a distance greater than one meter.

18. The storage medium of claim 15, wherein the sample contains taggant that has a luminescent response to the illumination by the laser.

19. The storage medium of claim 18, wherein the taggant consists of inorganic material.

20. The storage medium of claim 15, wherein the luminescent response of the sample has a decay time of greater than 10 milliseconds.
